(19) United States
(12) Patent Application Publication
(10) Pub. No.: US 2020/0410109 A1
(43) Pub. Date: Dec. 31, 2020

(54) SECURITY EVALUATION SYSTEM, SECURITY EVALUATION METHOD, AND PROGRAM

(71) Applicant: NEC Corporation, Minato-ku,Tokyo (JP)

(72) Inventors: Yoshiyuki YAMADA, Tokyo (JP); Yoshinobu OHTA, Tokyo (JP); Masaki INOKUCHI, Tokyo (JP)

(73) Assignee: NEC Corporation, Minato-ku, Tokyo (JP)

(21) Appl. No.: 16/975,908

(22) PCT Filed: Mar. 27, 2018
(86) PCT No.: PCT/JP2018/012564

§ 371 Date: Aug. 26, 2020

(51) Int. Cl. G06F 21/57

(52) U.S. Cl. CPC G06F 21/577; G06F 2221/034

(57) ABSTRACT

This security evaluation system includes a first graph generation part that generates a first evaluation graph representing a connection relationship between resources as a target for security evaluation; a second graph generation part that generates a second evaluation graph representing a connection relationship between areas where the resources are located; and display part that displays the first evaluation graph and the second evaluation graph in association with each other.

### FIELD

The present invention relates to a security evaluation system, a security evaluation method, and a program.

### BACKGROUND

PATENT LITERATURE (PTL) 1 discloses a security countermeasure support apparatus that can propose a security countermeasure execution portion that enables effective business protection in a target system. According to the gazette, this security countermeasure support apparatus includes an external storage device storing attribute information of each subsystem constituting each task in the target system. The security countermeasure support apparatus 10 includes an arithmetic unit that performs a process of applying the attribute information of each subsystem of each task to a predetermined algorithm to determine a risk level of each subsystem for each task. The arithmetic unit executes a process of determining the importance of the task by applying the determined risk level or attribute information to a predetermined algorithm and a process of calculating the number of tasks related to each subsystem based on the attribute information. Further, the arithmetic unit calculates the implementation priority of the security countermeasure for each subsystem based on the importance of each subsystem and the size of the number of tasks, and outputs information on the implementation priority to a predetermined apparatus.

PATENT LITERATURE 2 discloses a risk evaluation system that evaluates vulnerability risks based on the system configuration and topology in addition to the technical characteristics of each vulnerability and performs highly effective risk evaluation in response to the actual system status. The risk evaluation server that forms the risk evaluation system includes an apparatus that forms the target system of the risk evaluation, a network, and a storage device that stores information on vulnerability in association with each other. In addition, the risk evaluation server has an arithmetic unit that applies the above-described information to a predetermined algorithm based on graph theory and creates a risk evaluation model that defines an influence relationship of vulnerability according to the arrangement of each device on the network. Further, the arithmetic unit of the risk evaluation server applies the risk evaluation model to a predetermined inference algorithm, evaluates a risk caused by vulnerability in the target system, and outputs the evaluation result to the predetermined device.

PATENT LITERATURE 3 discloses a confidentiality analysis support system that can analyze a risk in consideration of a flow of a threat generated depending on a physical configuration status of a system to be analyzed. The confidentiality analysis support system includes attack flow model generation means for giving information indicating a function of the apparatus to a structural model representing a physical connection status of an apparatus constituting the information system and a behavior model representing a processing flow performed on the apparatus. Then, the attack flow model generation means generates an attack flow model representing an attack flow that may occur as a model for analyzing confidentiality in the information system.

PATENT LITERATURE 4 discloses a vulnerability risk evaluation system that can evaluate a risk related to vulnerability of a system that performs information processing on a predetermined business. This vulnerability risk evaluation system includes a vulnerability detection part that detects a vulnerability of an apparatus based on system configuration information and security information. The vulnerability risk evaluation system includes an apparatus risk evaluation model generation part that generates an apparatus risk evaluation model that evaluates a risk that a vulnerability may cause on an apparatus by arranging a vulnerability node and an apparatus node in association with each other. Further, the vulnerability risk evaluation system includes a business-related risk evaluation model generation part. The business-related risk evaluation model generation part additionally arranges the business-related node in the apparatus risk evaluation model and associates the business-related node with the apparatus node. Further, the business-related risk evaluation model generation part generates a business-related risk evaluation model for evaluating a risk that detected vulnerability may cause in a predetermined business process.

In addition, as a method of analyzing various methods for attacking an information system, a method using an attack graph has been studied. For example, PATENT LITERATURE 5 discloses a method for determining whether or not to implement a security policy with reference to the attack model when an attack is detected using an attack model prepared in advance.

### CITATION LIST

### Patent Literature

PATENT LITERATURE 1: Japanese Patent Kokai Publication No. JP-P2016-192176A
PATENT LITERATURE 2: Japanese Patent Kokai Publication No. JP-P2016-091402A
PATENT LITERATURE 3: International Publication Number WO2011/096162A1
PATENT LITERATURE 4: Japanese Patent Kokai Publication No. JP-P2017-224053A
PATENT LITERATURE 5: Japanese Patent Kohyou Publication No. JP-P2013-525927A

### SUMMARY

### Technical Problem

The following analysis has been made by the present invention. In the attack graph of FIG. 3 of PATENT LITERATURE (PTL) 5, an operation (attack action) that causes a state transition of the system is modeled as a node and order of occurrence of the attack action is represented by a link. On the other hand, in actual information systems, although measures for physically separating resources and networks or the like are taken in addition to various security countermeasures, there is a problem that it is difficult to grasp an effect of the separation and to take countermeasures with the above attack model alone.

As a typical example, an example of a computer worm called Stuxnet is taken. Stuxnet infects a target standalone computer via a Universal Serial Bus (USB) memory by way of a PC (Personal Computer) serving as a springboard. To prevent such infections, it is necessary to grasp paths of infection and take effective countermeasures, but it is difficult to assess the risk before an incident occurs.

It is an object of the present invention to provide a security evaluation system, a security evaluation method, and a program that contribute to enrichment of security evaluation schemes of an information system.

### Solution to Problem

According to a first aspect, there is provided a security evaluation system, including a first graph generation part that generates a first evaluation graph representing a connection relationship between resources as a target for security evaluation; a second graph generation part that generates a second evaluation graph representing a connection relationship between areas where the resources are located; and a display part that displays the first evaluation graph and the second evaluation graph in association with each other.

According to a second aspect, there is provided a security evaluation method, including a step of generating a first evaluation graph representing a connection relationship between resources as a target for security evaluation; a step of generating a second evaluation graph representing a connection relationship between areas where the resources are located; and a step of displaying the first evaluation graph and the second evaluation graph in association with each other. The present method is tied to a particular machine, namely, a computer having a function to generate and display a first evaluation graph and a second evaluation graph.

According to a third aspect, there is provided a program, causing a computer having a processor and a memory device to perform processes of: generating a first evaluation graph representing a connection relationship between resources as a target for security evaluation; generating a second evaluation graph representing a connection relationship between areas where the resources are located; and displaying the first evaluation graph and the second evaluation graph in association with each other. Further, this program may be stored in a computer-readable (non-transitory) storage medium. In other words, the present invention can be realized as a computer program product.

### Advantageous Effects of Invention

According to the present invention, it is possible to contribute to enrichment of security evaluation schemes of an information system.

### BRIEF DESCRIPTION OF THE DRAWINGS

FIG. 1 illustrates a configuration of an exemplary embodiment of the present invention.

FIG. 2 illustrates an operation of an exemplary embodiment of the present invention.

FIG. 3 illustrates a configuration of a security evaluation system according to a first exemplary embodiment of the present invention.

FIG. 4 illustrates an example of a configuration of an assessment graph generation part of the security evaluation system according to the first exemplary embodiment of the present invention.

FIG. 5 illustrates an example of a configuration of an asset graph generation part of the security evaluation system according to the first exemplary embodiment of the present invention.

FIG. 6 illustrates an example of asset information held by the security evaluation system according to the first exemplary embodiment of the present invention.

FIG. 7 illustrates an example of inter-asset connection information held by the security evaluation system according to the first exemplary embodiment of the present invention.

FIG. 8 illustrates an example of a configuration of a physical area graph generation part of the security evaluation system according to the first exemplary embodiment of the present invention.

FIG. 9 illustrates an example of physical area information held by the security evaluation system according to the first exemplary embodiment of the present invention.

FIG. 10 illustrates an example of inter-physical-area path information held by the security evaluation system according to the first exemplary embodiment of the present invention.

FIG. 11 illustrates an example of a configuration of an attack graph generation part of the security evaluation system according to a first exemplary embodiment of the present invention.

FIG. 12 illustrates an example of attack action information held by the security evaluation system according to the first exemplary embodiment of the present invention.

FIG. 13 illustrates an example of attack procedure information held by the security evaluation system according to the first exemplary embodiment of the present invention.

FIG. 14 illustrates a flowchart of an operation of the security evaluation system according to the first exemplary embodiment of the present invention.

FIG. 15 illustrates a flowchart representing an example of an assessment graph generation process of the security evaluation system according to the first exemplary embodiment of the present invention.

FIG. 16 illustrates an example of an assessment graph displayed by the security evaluation system according to the first exemplary embodiment of the present invention.

FIG. 17 illustrates another example of an assessment graph displayed by the security evaluation system according to the first exemplary embodiment of the present invention.

FIG. 18 illustrates other example of an assessment graph displayed by the security evaluation system according to the first exemplary embodiment of the present invention.

FIG. 19 illustrates a configuration of a security evaluation system according to a second exemplary embodiment of the present invention.

FIG. 20 illustrates an example of a configuration of an assessment graph generation part of the security evaluation system according to the second exemplary embodiment of the present invention.

FIG. 21 illustrates an example of a configuration of a physical area graph generation part of the security evaluation system according to the second exemplary embodiment of the present invention.

FIG. 22 illustrates an example of access right information held by the security evaluation system according to the second exemplary embodiment of the present invention.

FIG. 23 illustrates an example of an assessment graph displayed by the security evaluation system according to the second exemplary embodiment of the present invention.

FIG. 24 illustrates another mode for holding access right information according to the second exemplary embodiment of the present invention.

FIG. 25 illustrates a further mode for holding access right information according to the second exemplary embodiment of the present invention.

FIG. 26 illustrates a configuration of a security evaluation system according to a third exemplary embodiment of the present invention.

FIG. 27 illustrates an example of asset information held by the security evaluation system according to the third exemplary embodiment of the present invention.

FIG. 28 illustrates a flowchart of an operation of the security evaluation system according to the third exemplary embodiment of the present invention.

FIG. 29 illustrates an example of an assessment graph displayed by the security evaluation system according to the third exemplary embodiment of the present invention.

FIG. 30 illustrates another example of an assessment graph displayed by the security evaluation system according to the third exemplary embodiment of the present invention.

FIG. 31 illustrates a further example of an assessment graph displayed by the security evaluation system according to the third exemplary embodiment of the present invention.

FIG. 32 illustrates an example of a security evaluation platform that can cooperate with the present invention.

FIG. 33 illustrates a configuration of a computer formulating a security evaluation system of the present invention.

### DESCRIPTION OF EXEMPLARY EMBODIMENTS

First, an outline of an exemplary embodiment according to the present invention will be described with reference to the drawings. In the following outline, reference characters of the drawings are denoted to various elements for the sake of convenience to facilitate understanding of the present invention and they are not intended to limit the present invention to the exemplary embodiment as shown in the drawings. Further, connection lines between blocks in the drawings and the like referred to in the following description include both bidirectional and unidirectional. The one-way arrow schematically shows the flow of a main signal (data), and it does not exclude bidirectionality.

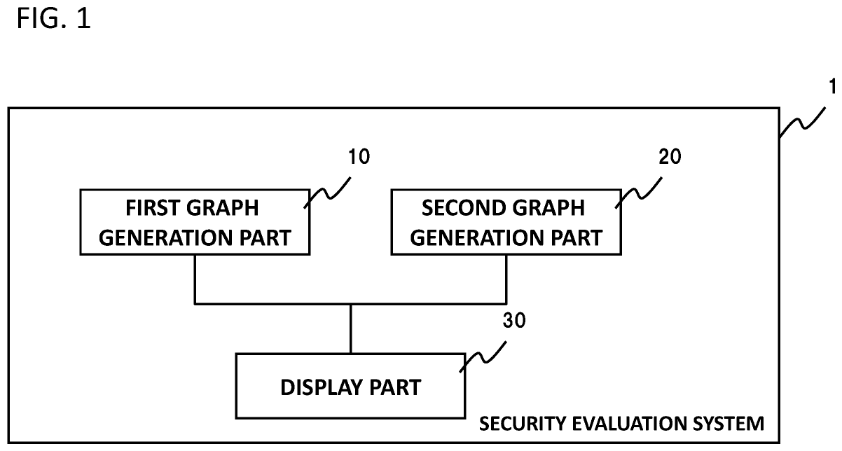

According to exemplary embodiment of the present invention, as shown in FIG. 1, the present invention is realized by a security evaluation system 1 including a first graph generation part 10, a second graph generation part 20 and a display part 30.

More concretely, the first graph generation part 10 generates a first evaluation graph representing a connection relationship between resources as a target for security evaluation. The second graph generation part 20 generates a second evaluation graph representing a connection relationship between areas where the resources are located. Further, the display part 30 displays the first evaluation graph and the second evaluation graph in association with each other.

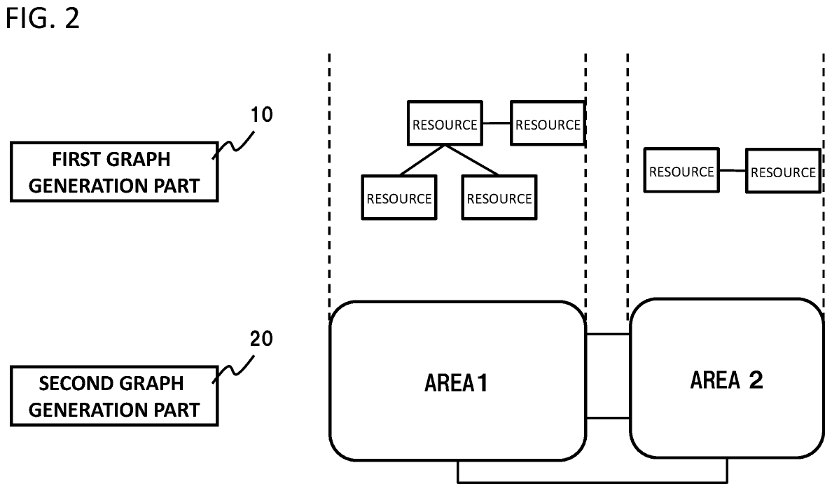

FIG. 2 illustrates an operation of an exemplary embodiment of the present invention. As shown on the upper right side of FIG. 2, the first graph generation part 10 generates a first evaluation graph representing a connection relationship between resources as a target for security evaluation. Such a first evaluation graph can be generated with reference to, for example, network configuration information and so on, prepared in advance.

On the other hand, as shown in the lower right part of FIG. 2, the second graph generation part 20 generates a second evaluation graph representing a connection relationship between areas where the resources are located. Such a second evaluation graph can be generated with reference to, for example, floor layout information and base location information and so on prepared in advance. In the example of FIG. 2, it can be seen that there are three paths between an area 1 and an area 2.

Then, the display part 30 displays the first evaluation graph and the second evaluation graph in association with each other, as shown by a broken line in FIG. 2. According to such graphs, on the first evaluation graph, although four resources on a left side and two resources on a right side are separated, it can be seen that there are three paths from the viewpoint of the physical areas. As for countermeasures against incidents via a USB memory or the like as typified by Stuxnet, it can be seen that a security policy may be revised or a check of belongings may be carried out when entering and exiting relating to the three paths in the second evaluation graph.

As described above, according to the present exemplary embodiment, it is possible to perform security evaluation in consideration of a physical area that is difficult to grasp from a first evaluation graph representing a connection relationship between resources or an attack graph.

### First Exemplary Embodiment

Next, a first exemplary embodiment of the present invention that can display an assessment graph in which three layers including an attack graph in addition to the first and second evaluation graphs are integrated will be described with reference to the drawings in detail. In the following description, “asset” corresponds to the “resource” as described above. That is, the term “asset” in the following description can be replaced with “resource”.

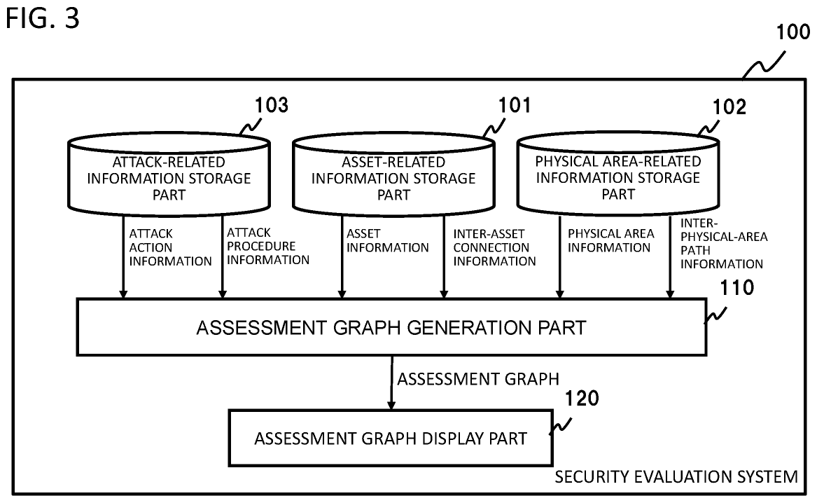

FIG. 3 illustrates a configuration of a security evaluation system according to a first exemplary embodiment of the present invention. Referring to FIG. 3, a configuration including an asset-related information storage part 101, a physical area-related information storage part 102, an attack-related information storage part 103, an assessment graph generation part 110 and an assessment graph display part 120 is shown.

The asset-related information storage part 101 stores asset information and inter-asset connection information. The physical area-related information storage part 102 stores physical area information and inter-physical-area path information. The attack-related information storage part 103 stores attack action information and attack procedure information. Concrete examples thereof will be described later in detail with reference to the drawings.

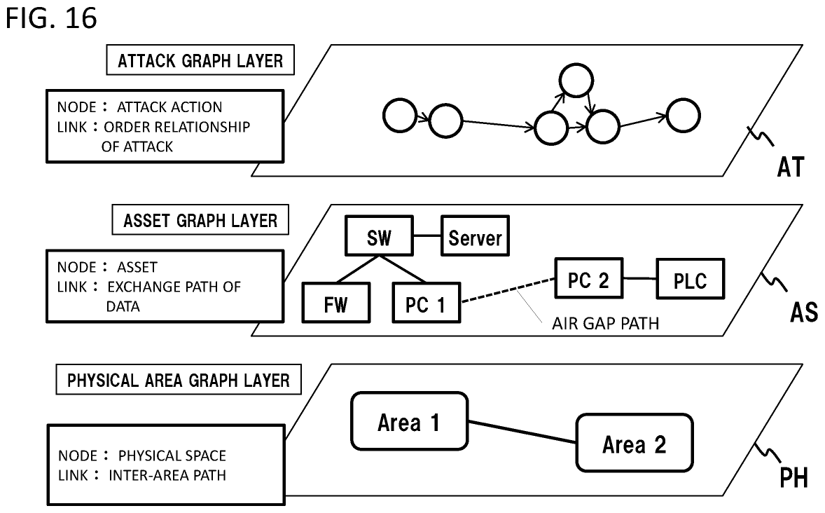

The assessment graph generation part 110 generates an assessment graph as exemplified by FIGS. 16 to 18 using information obtained from the asset-related information storage part 101, the physical area-related information storage part 102 and the attack-related information storage part 103.

The assessment graph display part 120 graphically displays the assessment graphs as exemplified by FIGS. 16 to 18.

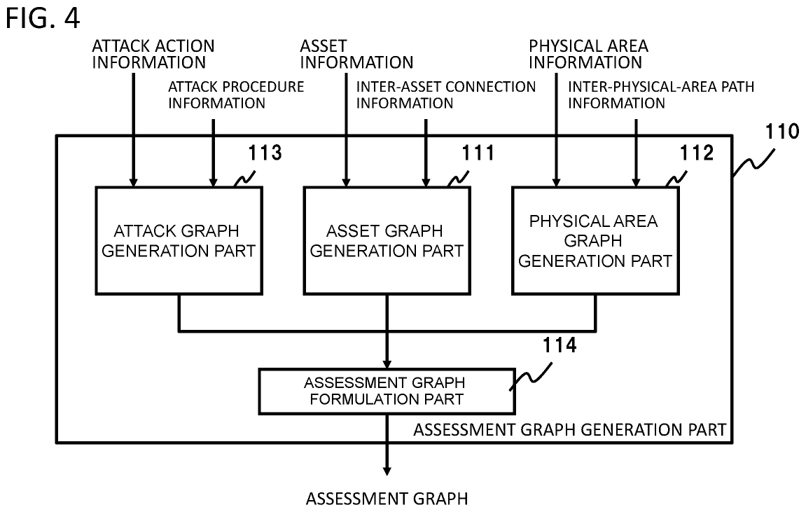

Next, a detailed configuration of the assessment graph generation part 110 will be described. FIG. 4 illustrates an example of a configuration of the assessment graph generation part of the security evaluation system according to the first exemplary embodiment of the present invention. Referring to FIG. 4, a configuration including an asset graph generation part 111, a physical area graph generation part 112, an attack graph generation part 113 and an assessment graph formulation part 114 is shown.

The asset graph generation part 111 generates an asset graph using an asset information and an inter-asset connection information as inputs. The asset graph is a graph representing a connection relationship between assets of a target system for evaluation and corresponds to the above-described first evaluation graph.

The physical area graph generation part 112 generates a physical area graph using physical area information and inter-physical-area path information as inputs. The physical area graph is a graph representing a connection relationship between physical areas of the target system for evaluation and corresponds to the above-described second evaluation graph. The concrete operation of the physical area graph generation part 112 will be described later in detail.

The attack graph generation part 113 generates an attack graph using attack action information and attack procedure information as inputs. The attack graph is a graph representing an assumed attack procedure to the target system for evaluation in the form of a state transition graph. Various modes of the attack graph have been proposed and in the present exemplary embodiment, it is explained using an attack graph in which the attack action of the attacker is represented as a node, and order relationship thereof is represented by a link (arrow). A concrete operation of the attack graph generation part 113 will be described later in detail.

The assessment graph formulation part 114 formulates the assessment graph that hierarchically displays the above-described asset graph, the physical area graph and the attack graph in association with each other (see FIGS. 16 to 18). Concrete aspects of the assessment graph and its effect will be described later in detail.

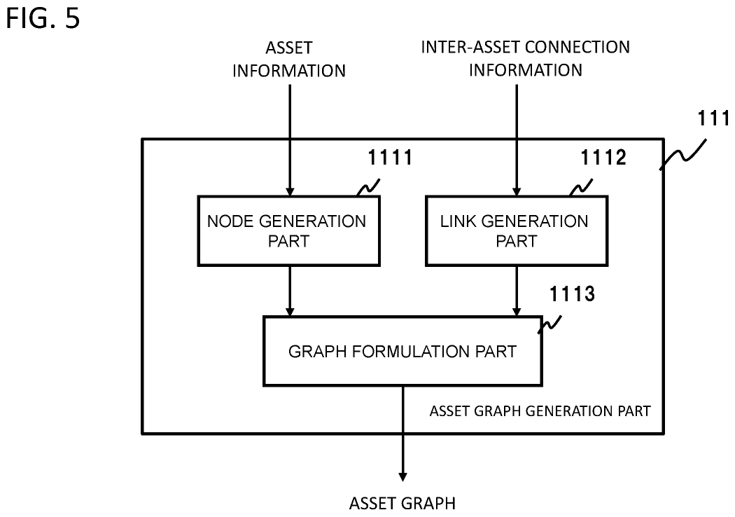

Next, an example of a concrete configuration of the above-described asset graph generation part 111, physical area graph generation part 112 and attack graph generation part 113 will be described. FIG. 5 illustrates an example of a configuration of the asset graph generation part 111. Referring to FIG. 5, a configuration including a node generation part 1111, a link generation part 1112 and a graph formulation part 1113 is shown.

The node generation part 1111 of the asset graph generation part 111 generates a node on an asset graph based on asset information.

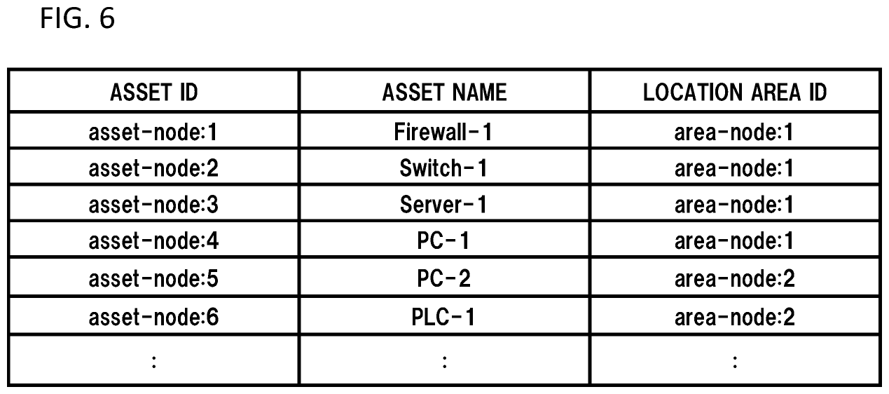

FIG. 6 illustrates an example of asset information held by the asset-related information storage part 101 In the example as shown in FIG. 6, an entry in which an asset ID uniquely indicating an asset, an asset name and a location area ID are associated is shown. For example, it is represented that the asset of asset-node:1 is a firewall device named Firewall-1 and is located in area 1. In FIG. 6, PLC stand for Programmable Logic Controller.

For example, the node generation part 1111 of the asset graph generation part 111 generates a node corresponding to asset-node:1 based on the asset information.

The link generation part 1112 of the asset graph generation part 111 generates a link on the asset graph based on the inter-asset connection information.

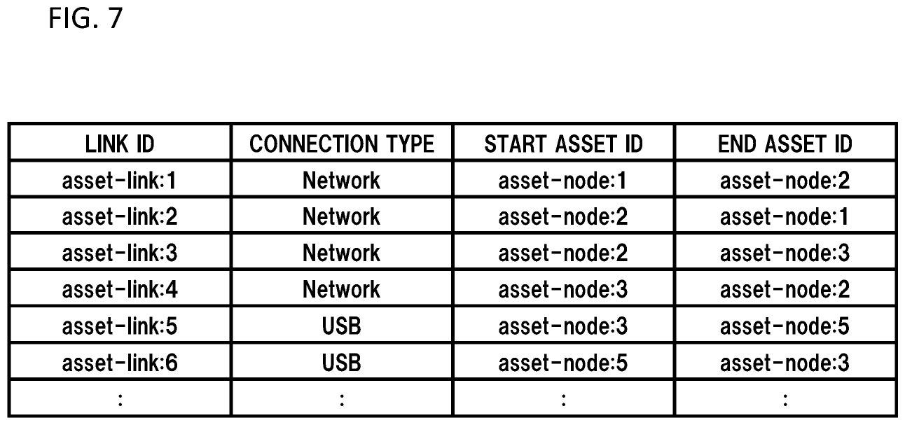

FIG. 7 illustrates an example of the inter-asset connection information held by the asset-related information storage part 101. In the example of FIG. 7, entries are shown in which a link ID uniquely indicating a link between assets, connection type information of the link, a start asset ID and an end asset ID are associated with each other. For example, it is represented that a link of asset-link: 1 is connected by a network and is a link between asset-node:1 and asset-node:2. In the example of FIG. 7, connection type information includes USB in addition to Network. USB indicates a data exchange path through transfer of a medium such as USB. A data exchange path through transfer of such a medium can be grasped through log information of a target device, an interview survey with a user, on-site observation, and so on. Further, only the USB is illustrated in the example of FIG. 7, but medium that can configure data exchange paths through transfer of the medium is not limited to this. For example, the exchange by inserting/removing other removable disks or modes by using a short-range wireless communication device as a medium are also applicable. Hereinafter, such a data exchange path though transfer of a medium is also referred to as an “air gap path”.

The graph formulation part 1113 of the asset graph generation part 111 generates an asset graph formulated by the nodes and links (see the middle part of FIGS. 16 to 18).

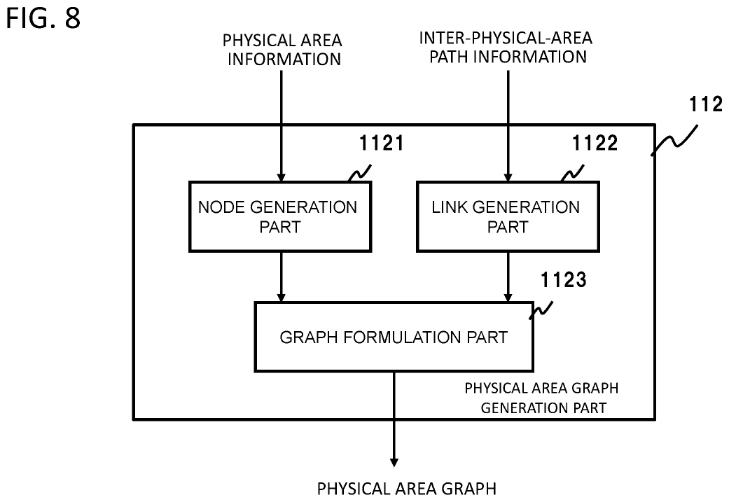

FIG. 8 is a diagram illustrating a configuration example of a physical area graph generation part 112. Referring to FIG. 8, a configuration including a node generation part 1121, a link generation part 1122 and a graph formulation part 1123 is represented.

The node generator 1121 of the physical area graph generator 112 generates a node on a physical area graph based on a physical area information.

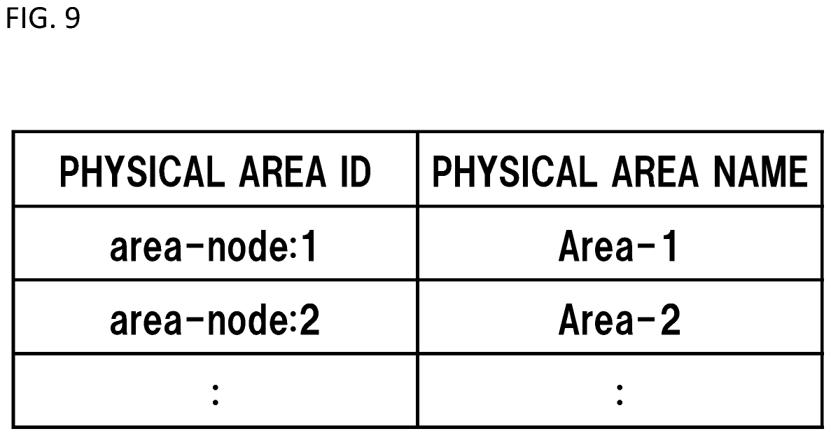

FIG. 9 illustrates an example of physical area information held by physical area-related information storage part 102. In the example of FIG. 9, entries are shown in which a physical area ID uniquely indicating a physical area is associated with a physical area name. For example, it is represented that the physical area of area-node:1 is an area named Area-1. The physical area refers to a space that is separated from other places by a certain type of barrier in the real world. Such physical areas include booths, rooms, floors, buildings, houses, districts, and the like. In addition, it is preferable that these spaces are demarcated by a predetermined access right such as entrance/exit management using an ID card.

For example, the node generation part 1121 of the physical area graph generation part 112 generates a node corresponding to area-node:1 based on the physical area information.

The link generation part 1122 of the physical area graph generation part 112 generates a link on a physical area graph based on the inter-physical-area path information.

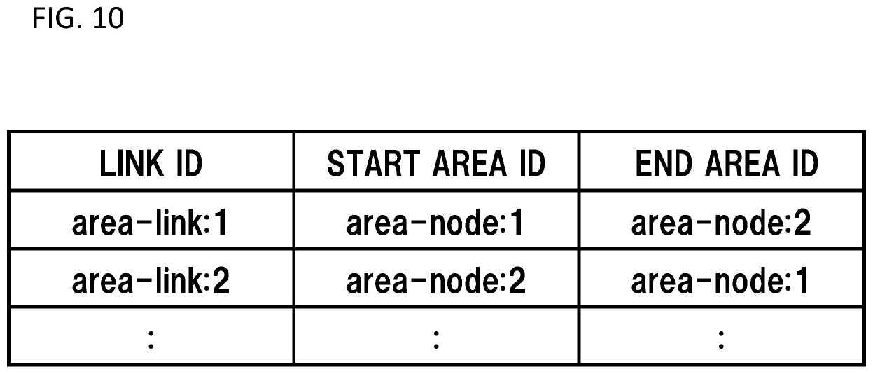

FIG. 10 illustrates an example of inter-physical-area path information held by the physical area-related information storage part 102. In the example of FIG. 10, entries are shown in which a link ID uniquely indicating a link between physical areas, a start physical area ID and an end physical area ID are associated with each other. For example, it is represented that a link of area-link:1 is a link between area-node:1 and area-node:2. It should be noted that connection type information of the link may be included in the inter-physical-area path information. The connection type information in the link between the physical areas can include whether or not there is a gate using an ID card, whether or not there is a check of belongings, and the like.

The graph formulation part 1123 of the physical area graph generation part 112 generates a physical area graph formulated by the nodes and links (see the lower part of FIGS. 16 to 18).

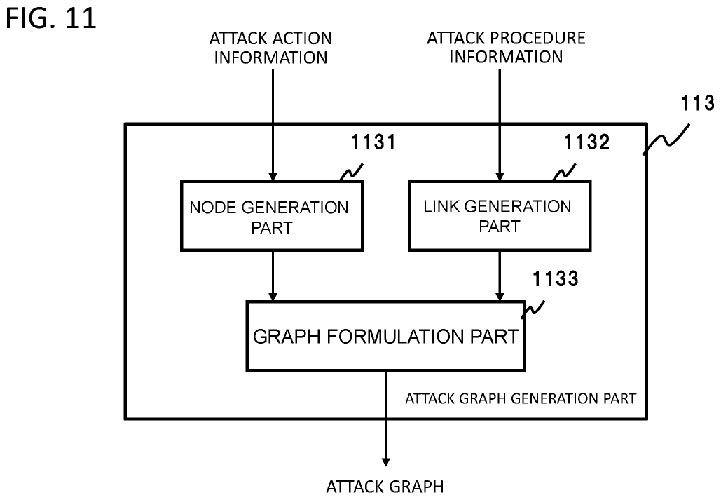

FIG. 11 illustrates an example of a configuration of an attack graph generation part 113. Referring to FIG. 11, a configuration including a node generation part 1131, a link generation part 1132 and a graph formulation part 1133 is represented.

The node generation part 1131 of the attack graph generation part 113 generates a node on an attack graph based on an attack action information.

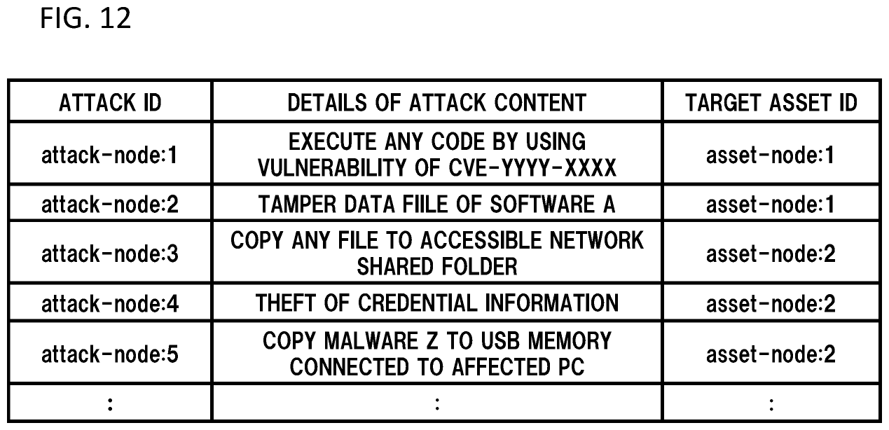

FIG. 12 illustrates an example of attack action information held by the attack-related information storage part 103. In the example of FIG. 12, entries are shown in which an attack ID that uniquely indicates an attack action, details of the attack content and a target asset ID to be attacked are associated with each other. For example, an attack of attack-node:1 is to execute a specific code by using a vulnerability of a system and it is indicated that a target is asset-node:1.

For example, the node generation part 1131 of the attack graph generation part 113 generates a node corresponding to attack-node:1 based on the attack action information.

The link generation part 1132 of the attack graph generation part 113 generates a link on an attack graph based on an attack procedure information.

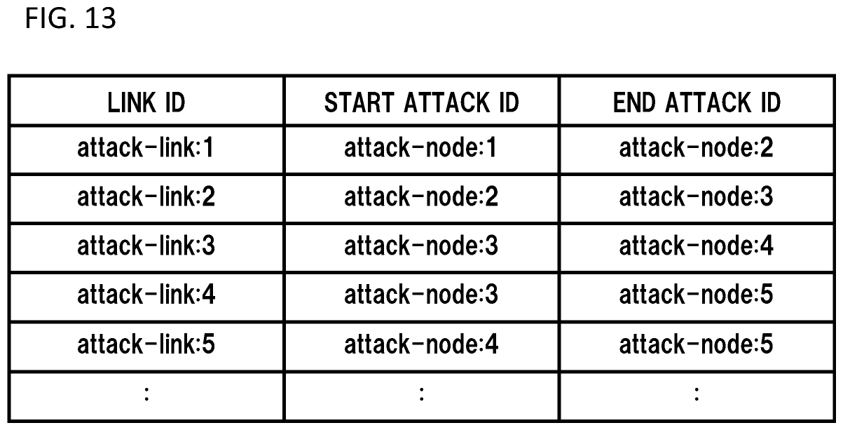

FIG. 13 illustrates an example of attack procedure information held by the attack-related information storage part 103. In the example of FIG. 13, entries are shown in which a link ID uniquely indicating a link between attacking actions, a start attack ID indicating a start node and an end attack ID indicating an end node are associated with each other. For example, it is shown that the link of attack-link:1 is a link between attack-node:1 and attack-node:2.

The graph formulation part 1133 of the attack graph generation part 113 generates an attack graph formulated by the nodes and the links (see the upper part of FIGS. 16 to 18).

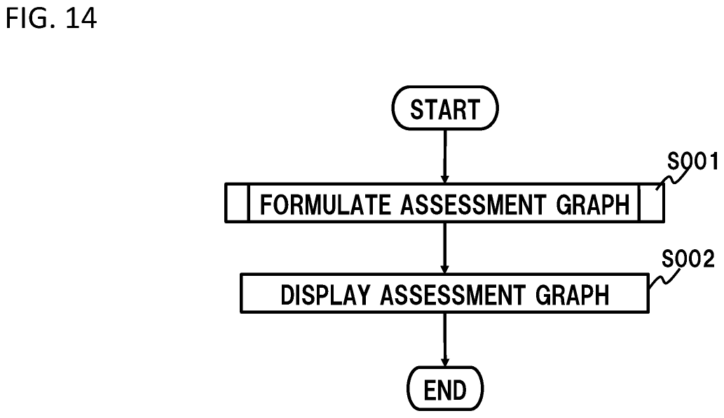

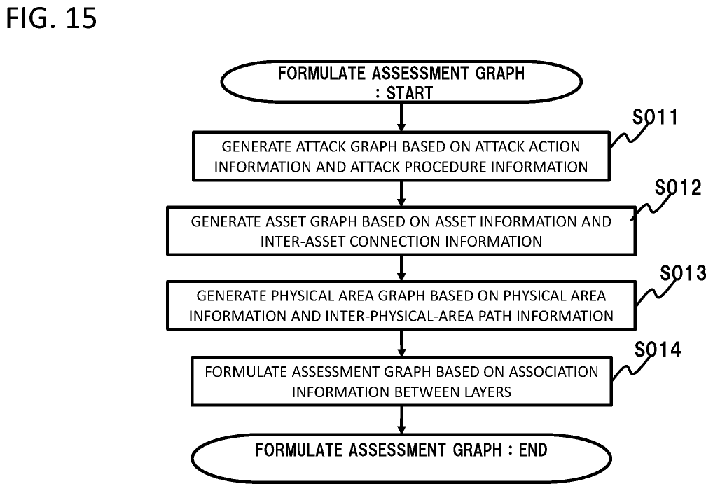

Next, the operation of the present exemplary embodiment will be described in detail with reference to the drawings. FIG. 14 illustrates a flowchart of an operation of a security evaluation system according to a first exemplary embodiment of the present invention. Referring to FIG. 14, first, an assessment graph generation part 110 of the security evaluation system 100 formulates an assessment graph. FIG. 15 is a flowchart illustrating an example of an assessment graph generation process performed by the assessment graph generation part 110.

Referring to FIG. 15, the attack graph generation part 113 of the security evaluation system 100 generates an attack graph based on attack action information and attack procedure information (step S011).

Next, the asset graph generation part 111 of the security evaluation system 100 generates an asset graph based on the asset information and the inter-asset connection information (step S012).

Next, the physical area graph generation part 112 of the security evaluation system 100 generates a physical area graph based on the physical area information and the inter-physical-area path information (step S013).

Finally, the assessment graph formulation part 114 of the security evaluation system 100 formulates an assessment graph based on association information between layers of the above-described asset graph, the physical area graph and the attack graph (step S014). Here, the “association information between layers” refers to information indicating a corresponding relationship with a node of a different layer resided in information of a certain layer, such as a location area ID in asset information and a target asset ID in attack action information.

Referring again to FIG. 14, the assessment graph display part 120 of the security evaluation system 100 displays the formulated assessment graph (step S002).

FIG. 16 illustrates an example of an assessment graph displayed at a stage of step S002. This assessment graph has a three layered structure and an attack graph layer AT in the top row displays an attack graph in which assumed attack actions are represented as nodes, respectively, and a relation of order between the attacks is indicated by a link (arrow), respectively. An asset graph layer AS in the middle row displays an asset graph in which assets of a system to be evaluated are represented as nodes and data exchange paths between assets are represented by links. The asset graph can also display a data exchange path (air gap path) through a medium such as a USB, and so on. In a physical area graph layer PH in the bottom row, a physical area graph is displayed in which physical spaces (areas) where the assets are located are represented as nodes and a path between the physical spaces is represented by a link. In FIG. 16, SW stands for Switch, and FW stands for Firewall.

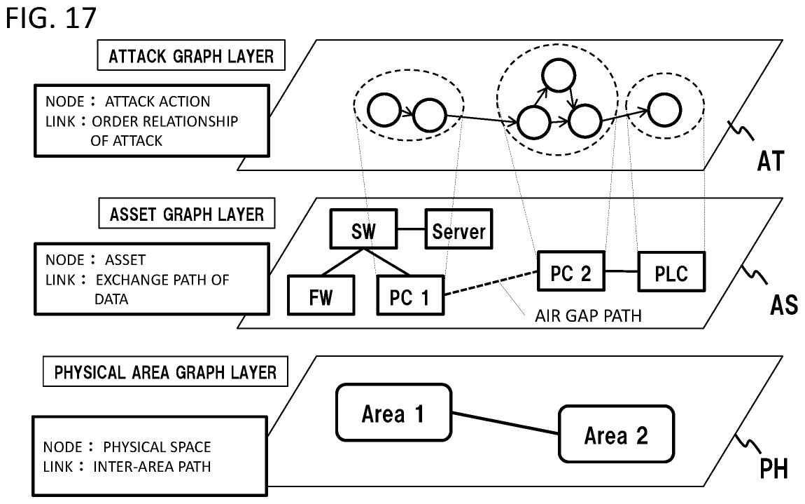

FIG. 17 illustrates another display mode of an assessment graph. In the example of FIG. 17, the correspondences between PC1, PC2 and PLC on an asset graph and nodes of an attack graph are indicated by broken lines. Such broken lines can be displayed by using the above-mentioned “association information between layers”. By looking at such a display, an evaluator of a system can grasp that the attack graph of FIG. 17 is established on the premise that an air gap path exists.

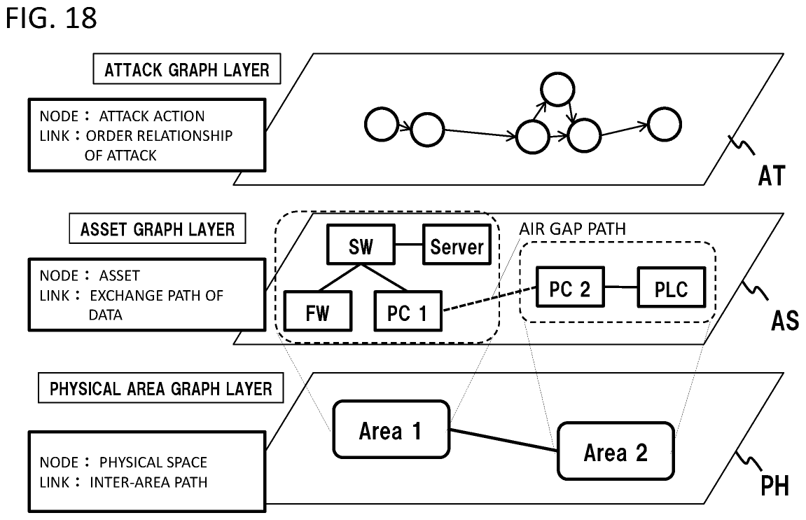

FIG. 18 illustrates another display mode of an assessment graph. In the example of FIG. 18, the correspondences between areas 1, 2 on a physical area graph and asset groups on an asset graph are indicated by broken lines. Such broken lines can be displayed by using the above-mentioned “association information between layers”. By looking at such a display, the evaluator of the system can determine he should take countermeasure against a path between the area 1 and the area 2 represented on the physical area graph in order to block the attack through the air gap path, which is the premise of the attack graph in the top raw of FIG. 18.

In the examples of FIGS. 16 to 18 described above, a node(s) in an attack graph layer is/are associated with any node in an asset graph layer based on asset information of a target for an attack. This means that nodes in the asset graph layer are defined as a group (superset) that encompasses nodes in the attack graph layer. Similarly, a node(s) in the asset graph layer is/are associated with any node in a physical area graph layer based on a physical area information where an asset(s) is/are located. This means that a node of the physical area graph layer is defined as a group (superset) that encompasses node(s) of the asset graph layer. By adopting such a configuration, it further becomes easy to narrow down a point against which a countermeasure for a physical area layer should be taken by identifying node(s) in an asset graph from any node and path in any attack graph. According to another viewpoint, by selecting an arbitrary node in an asset graph, it also becomes possible to grasp an attack action that may be applied to the node from an attack graph associated with such node.

On the other hand, a display mode of an assessment graph is not limited to the examples shown in FIGS. 16 to 18. For example, only an asset graph may be displayed and an attack graph and a physical area graph may be displayed in a form of a pop-up display as needed. Further, a mode in which only an asset graph is displayed and a mode in which an assessment graph is displayed may be switched-over and displayed. According to such a mode, detailed information of each asset (for example, asset information in FIG. 6) can be displayed at the same time in case where only the asset graph is displayed.

### Second Exemplary Embodiment

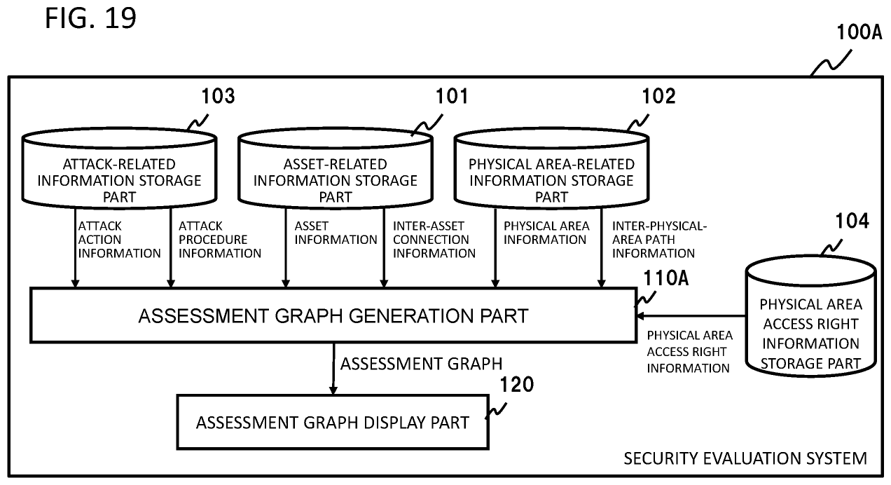

Next, a second exemplary embodiment in which display contents of a physical area graph are changed will be described in detail with reference to the drawings. FIG. 19 illustrates a configuration of a security evaluation system 100A according to a second exemplary embodiment of the present invention. The configuration difference from the security evaluation system 100 of the first exemplary embodiment shown in FIG. 3 is that a physical area access right information storage part 104 is appended and an assessment graph generation part 110A generates an assessment graph including a physical area access right. Other configurations are the same as those of the first exemplary embodiment and therefore the following description will focus on the differences.

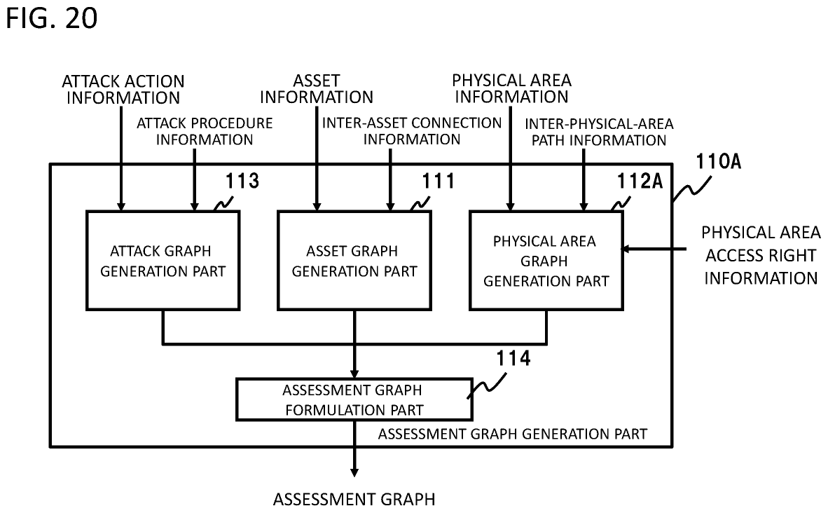

FIG. 20 illustrates an example of a configuration of an assessment graph generation part 110A according to the present exemplary embodiment. The difference from the assessment graph generation part shown in FIG. 4 is that physical area access right information is input to a physical area graph generation part 112A.

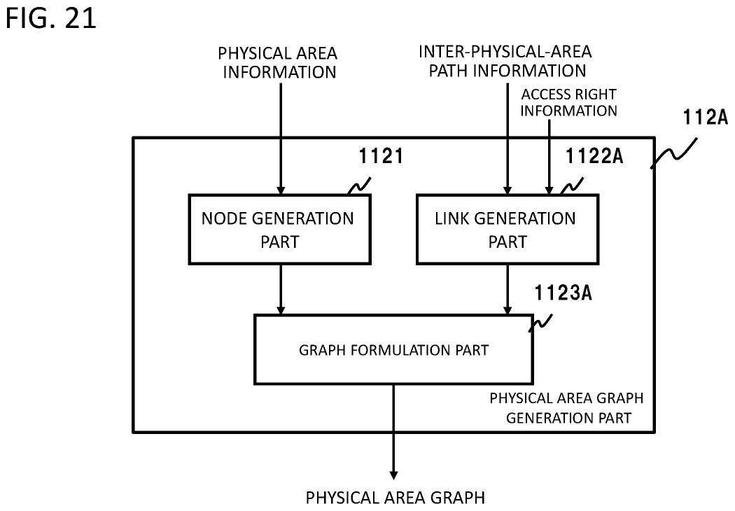

FIG. 21 illustrates an example of a configuration of a physical area graph generation part 112A according to the present exemplary embodiment. The difference from the physical area graph generation part as shown in FIG. 8 is that (physical area) access right information is input to a link generation part 1122A and the link generation part 1122A generates a link appended by the access right information.

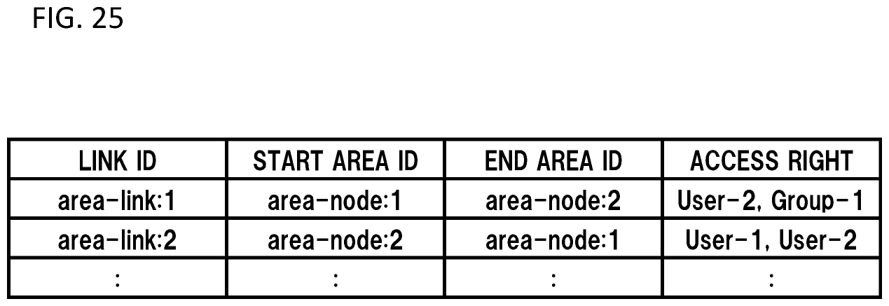

Then, a graph formulation part 1123A of the physical area graph generation part 112A of the present exemplary embodiment formulates a physical area graph in which access right information is appended to a link (see FIG. 25).

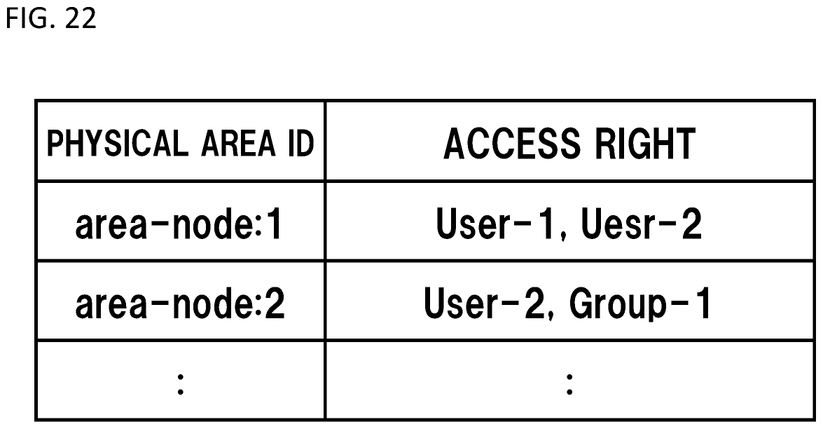

FIG. 22 illustrates an example of physical area access right information held by a physical area access right information storage part 104. In the example shown in FIG. 22, User-1 and User-2 are defined as users having access right to the physical area 1 identified by the ID of area-node:1. Similarly, User-2 and Group-1 are defined as users who have an access right to the physical area 2 identified by the ID of area-node:2. As described above, it is also possible to define a group as a user having access right. The physical area access right represents that access to a physical area is permitted by presentation of an ID card, face authentication means, and so on.

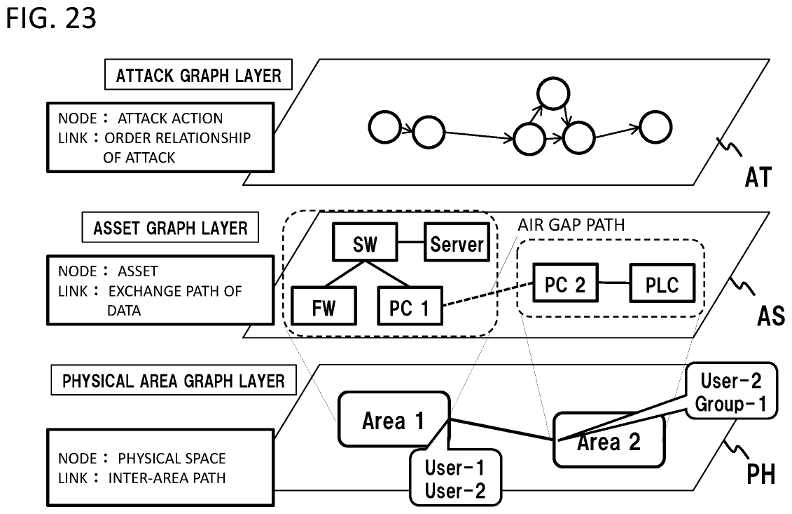

FIG. 23 illustrates an example of an assessment graph displayed by the security evaluation system 100A according to the second exemplary embodiment of the present invention. The difference from an assessment graph displayed by the security evaluation system 100 according to the first embodiment shown in FIGS. 16 to 18 is that information of a user(s) having access right is (are) displayed as information appended to a link in a physical area graph.

According to the present exemplary embodiment, in addition to an effect of the first exemplary embodiment, it becomes possible to narrow down user(s) who is (are) target(s) of security countermeasures in a physical area.

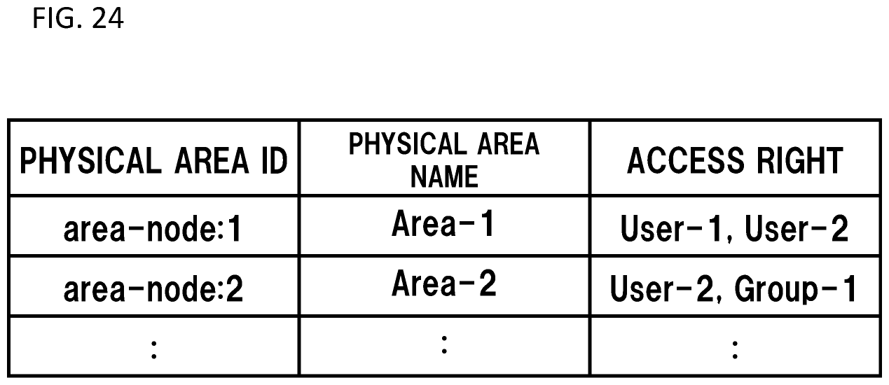

In the above description, although the physical area access right information storage part 104 is independently provided in the security evaluation system 100A, it is also possible to employ a configuration in which the physical area access right information storage part 104 is omitted. For example, as shown in FIG. 24, a mode in which an access right field for storing physical area access right information is added to and held in a physical area information can be adopted. Similarly, as shown in FIG. 25, a mode in which an access right field is added to an inter-physical-area path information to retain the physical area access right information can be adopted.

In the above exemplary embodiment, information of a user having an access right is held and displayed as an access right, but a subject having an access right is not limited to a user (human). For example, an entity having credential information may be displayed in addition to a user. Further, as additional information of an above-mentioned user name and credential information, an authentication method of these access rights may be provided and displayed together.

### Third Exemplary Embodiment

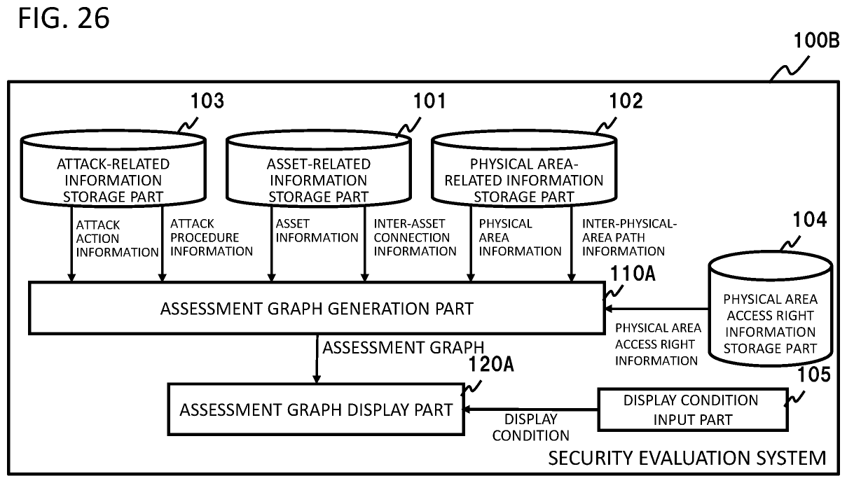

Next, a third exemplary embodiment in which the display mode of the assessment graph can be changed will be described in detail with reference to the drawings. FIG. 26 illustrates a configuration of a security evaluation system 100B according to a third exemplary embodiment of the present invention. The configuration difference from the security evaluation system 100A of the second exemplary embodiment shown in FIG. 19 is that a display condition input part 105 is added, and an assessment graph display part 120A changes a display mode of an assessment graph according to an input display condition. In this exemplary embodiment, an asset type field indicating a type of an asset is added to asset information. Other configurations are the same as those of the first and second exemplary embodiments, and therefore, the differences will be mainly described below.

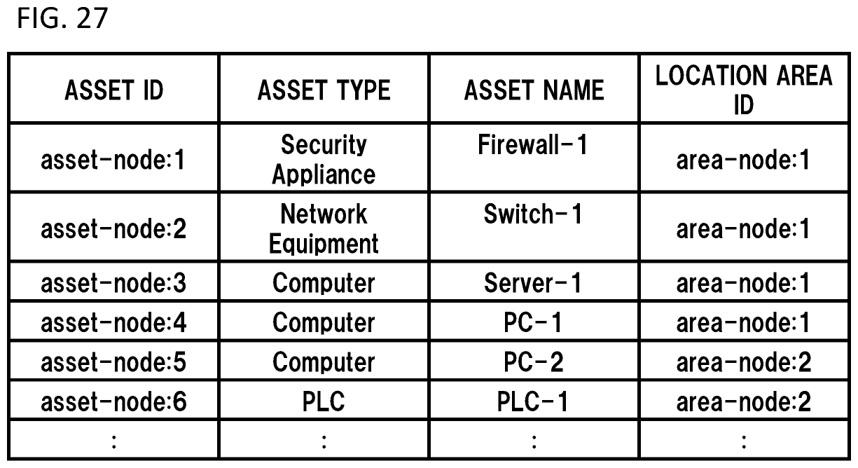

FIG. 27 illustrates an example of asset information held by the security evaluation system according to the third exemplary embodiment of the present invention. The difference from the asset information shown in FIG. 6 is that an asset type field has been added so that an asset type of a node on an asset graph can be identified.

The display condition input part 105 receives input of display conditions for displaying an assessment graph from a system evaluator or the like and transmits the input to the assessment graph display part 120A. The display conditions here may include a node ID of each layer and its attributes. For example, an attack ID corresponding to a node in an attack graph may be designated. Similarly, an asset type, an asset ID, and a connection type of a link in an asset graph may be designated. Similarly, a physical area ID and access right information in a physical area graph may be designated.

The assessment graph display part 120A displays an assessment graph according to a display condition designated by the display condition input part 105.

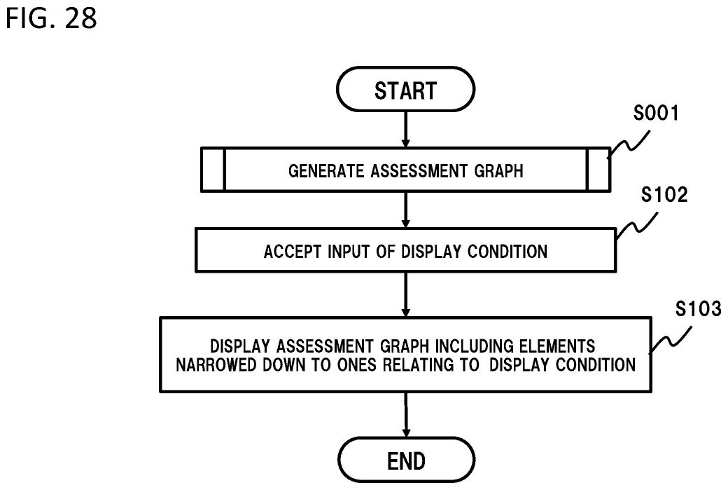

Subsequently, an operation of the present exemplary embodiment will be described in detail with reference to the drawings. FIG. 28 illustrates a flowchart of an operation of the security evaluation system 100B according to the present exemplary embodiment. The difference from the operation of the security evaluation system 100 according to the first embodiment shown in FIG. 14 is that in step S102, input of display condition is accepted, and a display mode of an assessment graph is changed according to the display conditions (steps S102 and S103 in FIG. 28).

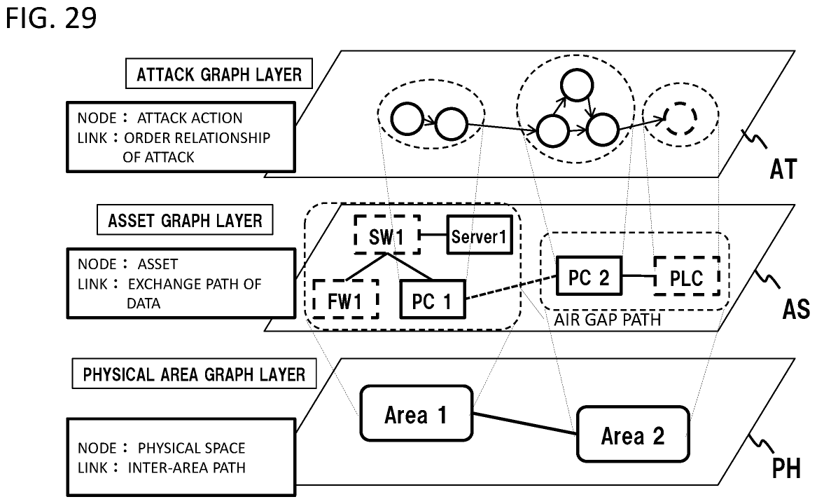

The input of the display condition and the display mode of the assessment graph will be concretely described with reference to FIGS. 29 to 31. FIG. 29 illustrates an assessment graph displayed when an asset type=Computer is designated as a display condition in the display condition input part 105. Because the asset type=Computer is designated as the display condition, Server-1, PC-1, and PC-2 of asset-node:3 to 5 are identified from asset information shown in FIG. 27. Then, the assessment graph display part 120A displays an asset graph (partial graph) representing at least Server-1, PC-1 and PC-2 as nodes as an asset graph (AS). The other nodes in the asset graph may be represented by broken lines as shown in FIG. 29 or may not be displayed. Further, in the example of FIG. 29, in an attack graph (AT), nodes of the attack graph corresponding to the above-mentioned Server-1, PC-1 and PC-2 are represented by solid lines, and correspondence relation is indicated by broken lines. In the example of FIG. 29, in a physical area graph, areas where Server-1, PC-1 and PC-2 are located are represented by a solid line and correspondence relation is represented by a broken line. According to such an assessment graph, it is possible to confirm whether or not there is an attack graph related to an arbitrary asset and an arrangement (location) on the physical area.

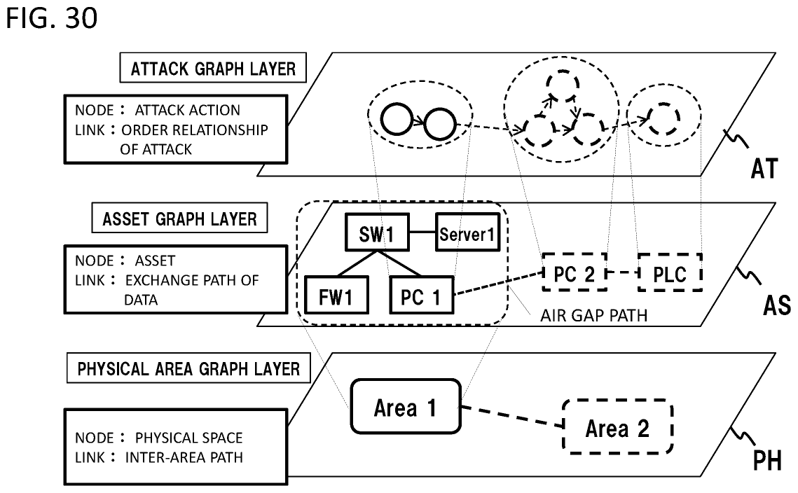

FIG. 30 illustrates an assessment graph displayed when Area 1 of a physical area graph is designated as a display condition in the display condition input part 105. Because the physical area name=Area 1 is designated as a display condition, Firewall-1, Switch-1, Server-1 and PC-1 with a location area ID of area-node:1 are identified from the asset information shown in FIG. 27. Then, the assessment graph display part 120A displays an asset graph (partial graph AS) representing at least nodes of Firewall-1 (FW1), Switch-1 (SW1), Server-1 and PC-1 as an asset graph. The other nodes in the asset graph may be represented by broken lines as shown in FIG. 30 or may not be displayed. Further, in the example of FIG. 30, in an attack graph (AT), nodes of the attack graph corresponding to the above-described Firewall-1, Switch-1, Server-1 and PC-1 are represented by solid lines, and correspondence relation is represented by broken lines. In the example of FIG. 30, in a physical area graph (PH), the Area 1 is represented by a solid line, and correspondence relation is indicated by broken lines. According to such an assessment graph, it is possible to confirm whether or not there is an attack graph or an asset(s) located in an arbitrary area.

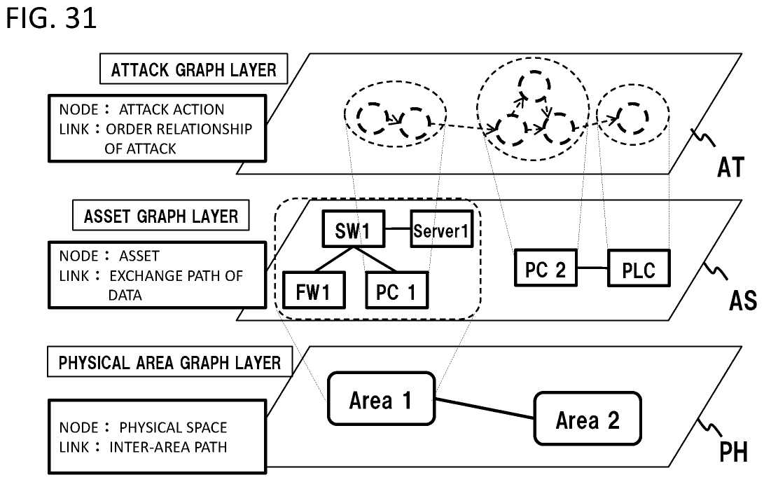

FIG. 31 illustrates an assessment graph displayed when a connection type of a link of an asset graph is designated to other than USB as a display condition in the display condition input part 105, that is, when “the presence of an air gap path is not a condition” is designated. Because the connection type=NOT (USB) is designated as the display condition, an entry of which connection type is other than USB is selected from inter-asset connection information of FIG. 7. Thereby, a link between PC1 and PC2 is not displayed in an asset graph. Further, in the example of FIG. 31, a link corresponding to an air gap path between PC1 and PC2 is represented by a broken line in an attack graph (AT). This shows that this attack graph cannot be established without the existence of the air gap path. Note that, although the example of FIG. 31 displays an attack graph, the attack graph may not be displayed in a case where it cannot be established without the presence of the air gap path. In contrast, when “the presence of an air gap path is a condition” is designated, the assessment graph as shown in FIG. 23 is displayed. According to such an assessment graph, it is possible to confirm an attack action using an air gap path and an attack paths before and after thereof from an attack graph. As a result, it becomes possible to draft countermeasures against attacks using the air gap path.

Display conditions are not limited to the above examples, and any items of asset information, inter-asset connection information, physical area information, inter-physical-area path information, attack action information, attack procedure information and access right information can be designated. For example, an arbitrary user may be designated as a display condition, and a physical area to which the user has access right, an attack graph and an asset graph portion corresponding to the physical area may be displayed. Similarly, for example, an arbitrary node (attack action) of an attack graph is designated as a display condition, and an asset of an asset graph being a target by the node (attack action) and a physical area where the asset is located may be displayed.

In a more desirable mode, when a link (path) of an attack graph is given weight information or the like calculated based on degree of influence (severity), difficulty of attack action, or the like, a path of an attack graph may be switched-over to be displayed or not based on these values. As these values, CVSS values known as Common Vulnerability Scoring System may be used, too.

As described above, each of exemplary embodiments of the present invention has been described. However, the present invention is not limited to the above-described exemplary embodiments, and further modifications, substitutions, and adjustments made without departing from the basic technical concept of the present invention can be added to. For example, the network configuration, the configuration of each element, and the expression form of a message illustrated in each drawing are examples for helping the understanding of the present invention and are not limited to the configurations illustrated in these drawings. In the following description, “A and/or B” is used to mean at least one of A or B.

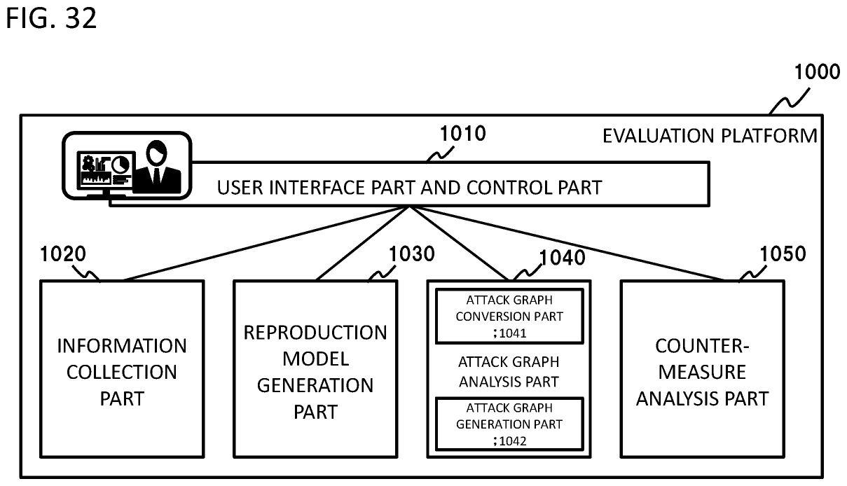

Although not particularly mentioned in the above exemplary embodiments, the present invention can also be applied as a subsystem of an evaluation platform 1000 of a system using a digital shadow as shown in FIG. 32. Here, the digital shadow is a method of evaluating security of a system using a reproduction model of a real system, also called a digital twin, and is suitable to use for systems in which it is difficult to perform tests on a real system such as a power plant system. In the example of FIG. 32, an evaluation platform 1000 including an information collection part 1020, a reproduction model generation part 1030, an attack graph analysis part 1040 and a countermeasure analysis part 1050 is illustrated. The attack graph analysis part 1040 among these corresponds to the above-described attack graph generation part 113. For example, the present invention can be configured as a system that operates in cooperation with the attack graph analysis part 1040 shown in FIG. 32.

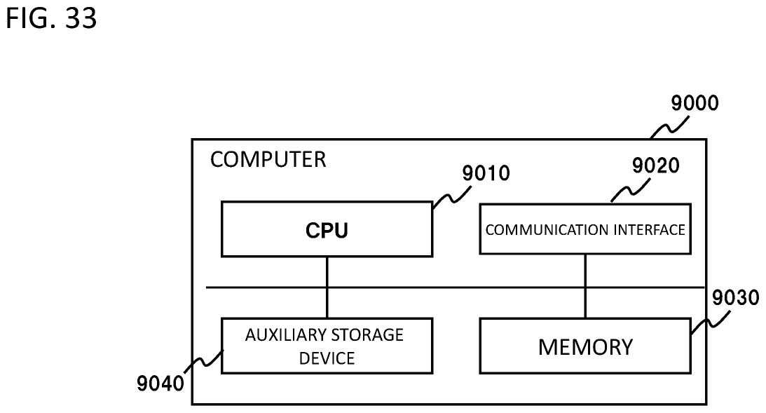

Procedures described in the first to third exemplary embodiments can be realized by a program that causes a computer (9000 in FIG. 33) functioning as a security evaluation system 100, 100A, and 100B to perform functions of a security evaluation system 100. Such a computer is exemplified by a configuration including a CPU (Central Processing Part) 9010, a communication interface 9020, a memory 9030, and an auxiliary storage device 9040 as shown in FIG. 33. That is, the CPU 9010 shown in FIG. 33 may execute an assessment graph generation program or an assessment graph display program and update the calculation parameters stored in the auxiliary storage device 9040 or the like.

That is, each part (processing means, function) of a security evaluation system as shown in the first to third exemplary embodiments can be realized by a computer program that causes a processor of the computer to execute each of the above processes using its hardware.

Finally, preferred exemplary embodiments of the present invention are summarized.

[Mode 1]

(Refer to the security evaluation system of the first aspect.)

[Mode 2]

It is preferable that the first graph generation part of the security evaluation system generates a first evaluation graph representing a data exchange path by way of a medium between the resources based on connection information between resources defining a data exchange path including a data exchange path by way of a medium between the resources.

[Mode 3]

It is preferable that the second graph generation part of the security evaluation system generates a second evaluation graph in which a physically demarcated space among areas where resources are located is represented as a node and a physical path connecting the spaces is represented as a link.

[Mode 4]

The security evaluation system can further have a configuration including:

an access right storage part that stores a user who is allowed to enter the space,

wherein the display part displays information of a user who is allowed to enter the space as additional information of the second evaluation graph.

[Mode 5]

The security evaluation system can further have a configuration including:

a third graph generating part that generates an attack graph for a resource as a target for the security evaluation,

wherein the display part further displays the first evaluation graph and the third evaluation graph in association with each other.

[Mode 6]

The security evaluation system can further have a configuration including:

a condition receiving part that receives a display condition including at least one designation of ID of the resource or type of the resource,

wherein the display part displays a resource corresponding to the display condition of the first evaluation graph and the second evaluation graph corresponding to the resource or an attack graph related to the resource.

[Mode 7]

The security evaluation system can further have a configuration including:

a condition receiving part that receives a display condition including designation of an area where the resource is located,

wherein the display part displays an area corresponding to the display condition of the second evaluation graph, a partial graph of the first evaluation graph related to the area and an attack graph related to the partial graph.

[Mode 8]

The security evaluation system can further have a configuration including:

a condition receiving part that receives designation of the presence or absence of a data exchange path by way of a medium between the resources among the data exchange paths,

wherein the display part displays a first evaluation graph without a data exchange path by way of a medium between the resources and an attack graph that does not need presence of a data exchange path by dislocation of a medium between the resources among attack graphs related to the first evaluation graph when the designation of absence of the data exchange path by way of the medium between the resources is received.

[Mode 9]

The security evaluation system can further have a configuration including:

a condition receiving part that receives a display condition including designation of the user,

wherein the display part selects a space in the second evaluation graph which the user is allowed to enter, and

displays a partial graph of the first evaluation graph representing resources located in the space and an attack graph related to the partial graph.

[Mode 10]

The security evaluation system can further have a configuration including:

a condition receiving part that receives a display condition including designation of a node of the attack graph;

wherein the display part displays a partial graph of the first evaluation graph related to the designated node of the attack graph and a partial graph of the second evaluation graph related to the partial graph.

[Mode 11]

(Refer to the security evaluation provision method of the second aspect.)

[Mode 12]

(Refer to the program of the third aspect.)

The modes 11 to 12 can be expanded to the second to tenth modes as is the case with the first mode.

The disclosures of the above patent literatures are incorporated herein by reference. Modifications and adjustments of the exemplary embodiments or examples are possible within the ambit of the entire disclosure (including the claims) of the present invention and based on the basic technical concept thereof. In addition, various combinations of various disclosed elements (including each element of each claim, each element of each exemplary embodiment or example, each element of each drawing, and the like) or selection are possible within the scope of the disclosure of the present invention. That is, the present invention of course includes various variations and modifications that could be made by those skilled in the art according to the entire disclosure including the claims and the technical concept. In particular, with respect to the numerical ranges described herein, any numerical values or small range(s) included in the ranges should be construed as being expressly described even if not otherwise explicitly recited.

### REFERENCE SIGNS LIST

1, 100, 100A, 100B security evaluation system
10 first graph generation part
20 second graph generation part
30 display part
101 asset-related information storage part
102 physical area-related information storage part
103 attack-related information storage part
104 physical area access right information storage part
105 display condition input part
110, 110A assessment graph generation part
111 asset graph generation part
112, 112A physical area graph generation part
113 attack graph generation part
114 assessment graph formulation part
120, 120A assessment graph display part
1000 evaluation platform
1010 user interface part and control part
1020 information collection part
1030 reproduction model generation part
1040 attack graph analysis part
1050 countermeasure analysis part
1111, 1121, 1131 node generation part
1112, 1122, 1122A, 1132 link generation part
1113, 1123, 1123A, 1133 graph formulation part
9000 computer
9010 CPU
9020 communication interface
9030 memory
9040 auxiliary storage device
AT attack graph layer
AS asset graph layer
PH physical area layer

What is claimed is:

1. A security evaluation system, comprising:
a first graph generation part that generates a first evaluation graph representing a connection relationship between resources as a target for security evaluation;
a second graph generation part that generates a second evaluation graph representing a connection relationship between areas where the resources are located; and
a display part that displays the first evaluation graph and the second evaluation graph in association with each other.

2. The security evaluation system according to claim 1,
wherein the first graph generation part generates a first evaluation graph representing a data exchange path by way of a medium between the resources based on connection information between resources defining a data exchange path including a data exchange path by way of a medium between the resources.

3. The security evaluation system according to claim 1,
wherein the second graph generation part generates a second evaluation graph in which a physically demarcated space among areas where resources are located is represented as a node and a physical path connecting the spaces is represented as a link.

4. The security evaluation system according to claim 1, further comprising:
an access right storage part that stores a user who is allowed to enter the space,
wherein the display part displays information of a user who is allowed to enter the space as additional information of the second evaluation graph.

5. The security evaluation system according to claim 1, further comprising:
a third graph generating part that generates an attack graph for a resource as a target for the security evaluation,
wherein the display part further displays the first evaluation graph and the third evaluation graph in association with each other.

6. The security evaluation system according to claim 1, further comprising:
a condition receiving part that receives a display condition including at least one designation of ID of the resource or type of the resource,
wherein the display part displays a resource corresponding to the display condition of the first evaluation graph and the second evaluation graph corresponding to the resource or an attack graph related to the resource.

7. The security evaluation system according to claim 1, further comprising:
a condition receiving part that receives a display condition including designation of an area where the resource is located,
wherein the display part displays an area corresponding to the display condition of the second evaluation graph, a partial graph of the first evaluation graph related to the area and an attack graph related to the partial graph.

8. The security evaluation system according to claim 2, further comprising:
a condition receiving part that receives designation of presence or absence of a data exchange path by way of a medium between the resources among the data exchange paths,
wherein the display part displays a first evaluation graph without a data exchange path by way of a medium between the resources and an attack graph that does not need presence of a data exchange path by dislocation of a medium between the resources among attack graphs related to the first evaluation graph, when the designation of absence of the data exchange path by way of the medium between the resources is received.

9. A security evaluation method, comprising:
generating a first evaluation graph representing a connection relationship between resources as a target for security evaluation;
generating a second evaluation graph representing a connection relationship between areas where the resources are located; and
displaying the first evaluation graph and the second evaluation graph in association with each other.

10. A computer-readable non-transient recording medium recording a program, the program, causing a computer comprising a processor and a memory device to perform processes of:
generating a first evaluation graph representing a connection relationship between resources as a target for security evaluation;
generating a second evaluation graph representing a connection relationship between areas where the resources are located; and
displaying the first evaluation graph and the second evaluation graph in association with each other.

11. The method according to claim 9,
wherein in the generating the first evaluation graph, a first evaluation graph representing a data exchange path by way of a medium between the resources is generated based on connection information between resources defining a data exchange path including a data exchange path by way of a medium between the resources.

12. The method according to claim 9,
wherein in the generating a second evaluation graph, a second evaluation graph in which a physically demarcated space among areas where resources are located is represented as a node and a physical path connecting the spaces is represented as a link is generated.

13. The method according to claim 9, further comprising:
an access right storage storing a user who is allowed to enter the space,
wherein in the displaying, information of a user who is allowed to enter the space as additional information of the second evaluation graph is displayed.

14. The method according to claim 9, further comprising:
a third graph generating of generating an attack graph for a resource as a target for the security evaluation,
wherein in the displaying, the first evaluation graph and the third evaluation graph are further displayed in association with each other.

15. The method according to claim 9, further comprising:
receiving a display condition including at least one designation of ID of the resource or type of the resource,
wherein in the displaying, a resource corresponding to the display condition of the first evaluation graph and the second evaluation graph corresponding to the resource or an attack graph related to the resource are displayed.

16. The medium according to claim 10,
wherein in the process of generating the first evaluation graph, a first evaluation graph representing a data exchange path by way of a medium between the resources is generated based on connection information between resources defining a data exchange path including a data exchange path by way of a medium between the resources.

17. The medium according to claim 10,
wherein in the process of generating a second evaluation graph, a second evaluation graph in which a physically demarcated space among areas where resources are located is represented as a node and a physical path connecting the spaces is represented as a link is generated.

18. The medium according to claim 10, further comprising:
an access right storage process of storing a user who is allowed to enter the space,
wherein in the process of displaying, information of a user who is allowed to enter the space as additional information of the second evaluation graph is displayed.

19. The medium according to claim 10, further comprising:
a third graph generating process of generating an attack graph for a resource as a target for the security evaluation,
wherein in the process of displaying, the first evaluation graph and the third evaluation graph are further displayed in association with each other.

20. The medium according to claim 10, further comprising:
a process of receiving a display condition including at least one designation of ID of the resource or type of the resource,
wherein in the process of displaying, a resource corresponding to the display condition of the first evaluation graph and the second evaluation graph corresponding to the resource or an attack graph related to the resource are displayed.
